(19) United States
(12) Patent Application Publication
(10) Pub. No.: US 2018/0195862 A1
(43) Pub. Date: Jul. 12, 2018

(54) SURVEYING TARGET ASSEMBLY

(71) Applicant: J T Networks Ltd., Cheddar Somerset (GB)

(72) Inventor: JAMES REED, Cheddar Somerset (GB)

(21) Appl. No.: 15/866,619

(22) Filed: Jan. 10, 2018

(30) Foreign Application Priority Data
Jan. 10, 2017 (GB) 1700362.5

(51) Int. Cl. G01C 15/06; G01C 15/04; G02B 5/12; G02B 7/18

(52) U.S. Cl. CPC G01C 15/06; G02B 7/1805; G02B 5/12; G01C 15/04

(57) ABSTRACT

A surveying target assembly is disclosed for monitoring movements in surveyed bodies, such as buildings and rail tracks. The assembly comprises a docking bay and a radiation reflecting target which is arranged to detachably couple with the docking bay.

The present invention relates to a surveying target assembly.

### CROSS-REFERENCE TO RELATED APPLICATIONS

This application claims priority to United Kingdom Patent Application No. 1700362.5 filed Jan. 10, 2017, the contents of which are incorporated herein by reference for all purposes.

In order to monitor movements associated with rail tracks over a period of time, it is common to secure a plurality of targets along each track and to illuminate each target with a beam of radiation, such as a laser beam, from a reference position. The beam of radiation is separately aligned to a centre of each target and the beam direction relative to the reference position for each target is recorded. Over a period of time, the separation of the rail tracks, namely the gauge, and any twisting of the tracks relative to each other, namely the cant, may vary such as due to land subsidence or settling. In order to assess the amount of any movement, the beam of radiation is again directed to each target along the respective, initially recorded beam direction, from the same reference position, and any movement in the tracks will manifest as a misalignment of the beam relative to the target. Accordingly, the steering required to re-align the beam with the target provides a measure of the amount and direction of track movement.

The above technique requires a surveyor or similar to rigidly secure a number of targets along the tracks which is a timely exercise. Moreover, once the survey has been performed, then the targets are typically left in situ upon the tracks. It is typically not possible to reuse the targets at a different site.

We have now devised an improved surveying target assembly.

In accordance with the present invention, there is provided a surveying target assembly comprising a docking bay and a radiation reflecting target which is arranged to detachably couple with the docking bay.

In an embodiment, the target comprises a base and a housing which extends from the base. The target preferably comprises a retroreflector, which may be disposed within the housing. The housing comprises a plurality of walls and at least one of the walls comprises a window, such that radiation incident upon the target can pass through the window onto the retroreflector.

In an embodiment, the retroreflector comprises a prism. The prims may comprise reflective coatings disposed on a plurality of the prism facets for reflecting the radiation.

In an embodiment, the housing comprises a front and rear wall and at least the front wall is acutely orientated with respect to the base. The window is preferably disposed in the front wall and may comprise a cross-sectional area which decreases in a direction which is into the housing. In this respect, a reveal of the window may comprise a conical taper, for example, so that radiation can be admitted through the window through an increased angular range.

In an embodiment, an interior of the housing is accessible via an opening formed in the base. The target further comprises a cradle which is arranged to receive the retroreflector and support the retroreflector within the housing. The cradle is preferably detachably coupleable within the housing, via the opening.

In an embodiment, the docking bay comprises a channel formed along opposing sides thereof for separately receiving a respective side edge of the target base. The target is arranged to detachably couple with the docking bay by locating side edges of the target base within a respective channel and sliding the target with respect to the docking bay. The channels are formed between a base plate of the docking bay and at least one flange which extends along a periphery of the base plate, over a portion of the base plate. In an embodiment, the docking bay further comprises a stop for limiting movement of the target with respect to the docking bay.

In an embodiment, the assembly further comprises locking means for releasably locking the radiation reflecting target to the docking bay.

In an embodiment, the locking means comprises a tongue which secured at a distal end thereof to the target base, and is resiliently biased to extend in a plane of the target base, and a recess formed in the base plate. The tongue preferably comprises a barb disposed at an underside thereof, which is arranged to snap locate within the recess to lock the target with respect to the docking bay. The tongue preferably further comprises a protuberance disposed at a proximal end thereof for enabling a user to manipulate the tongue to unlock the target from the docking bay.

In an embodiment, the base plate further comprises at least one aperture formed therein for receiving fasteners, such as screws and bolts, for securing the docking bay to a body for surveying.

Whilst the invention has been described above, it extends to any inventive combination of features set out above or in the following description. Although illustrative embodiments of the invention are described in detail herein with reference to the accompanying drawings, it is to be understood that the invention is not limited to these precise embodiments.

Furthermore, it is contemplated that a particular feature described either individually or as part of an embodiment can be combined with other individually described features, or parts of other embodiments, even if the other features and embodiments make no mention of the particular feature. Thus, the invention extends to such specific combinations not already described.

The invention may be performed in various ways, and, by way of example only, embodiments thereof will now be described with reference to the accompanying drawings, in which:

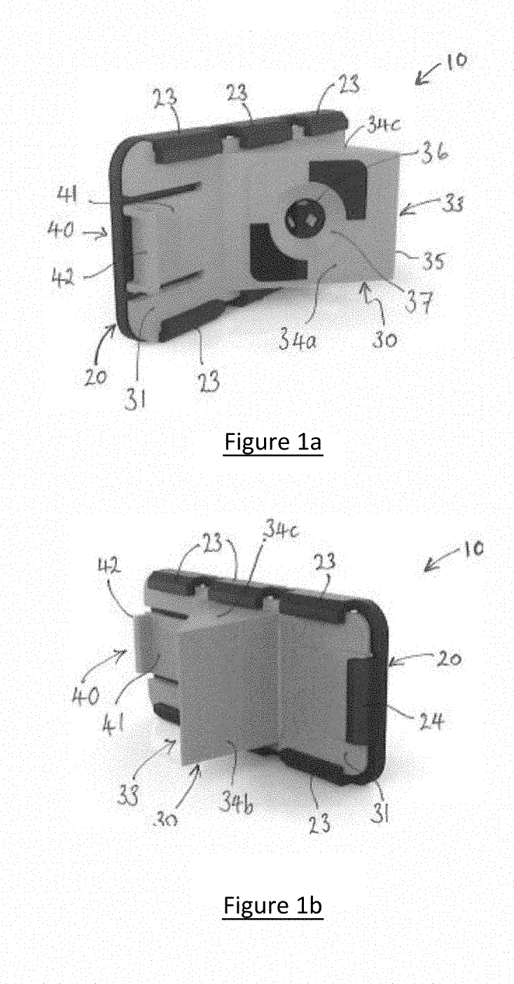

FIG. 1a is a perspective view of the surveying target assembly according to a first embodiment of the present invention;

FIG. 1b is an alternative perspective view of the surveying target assembly according to the first embodiment of the present invention;

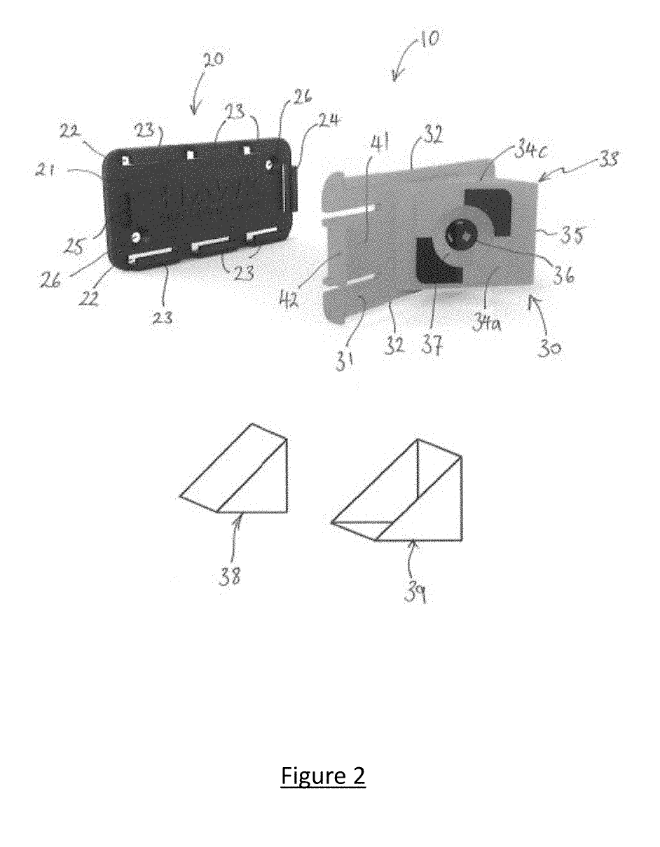

FIG. 2 is an exploded view of the surveying target assembly illustrated in FIG. 1a;

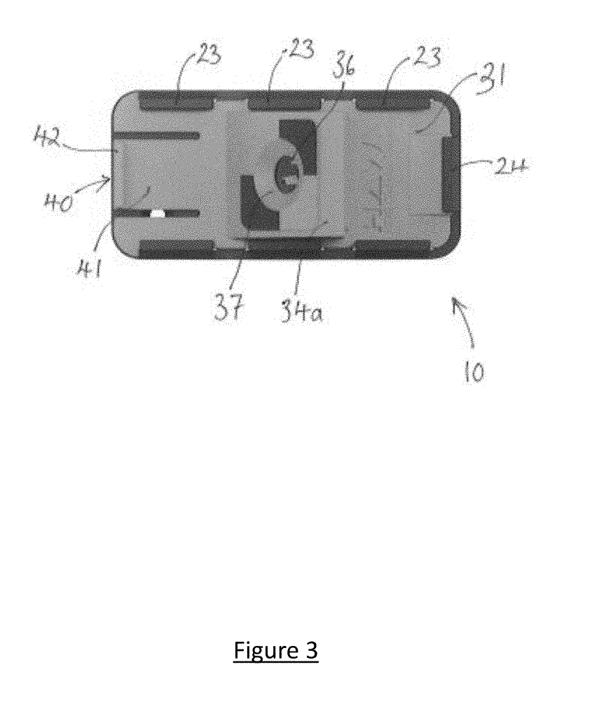

FIG. 3 is a plan view of the surveying target assembly illustrated in FIG. 1a;

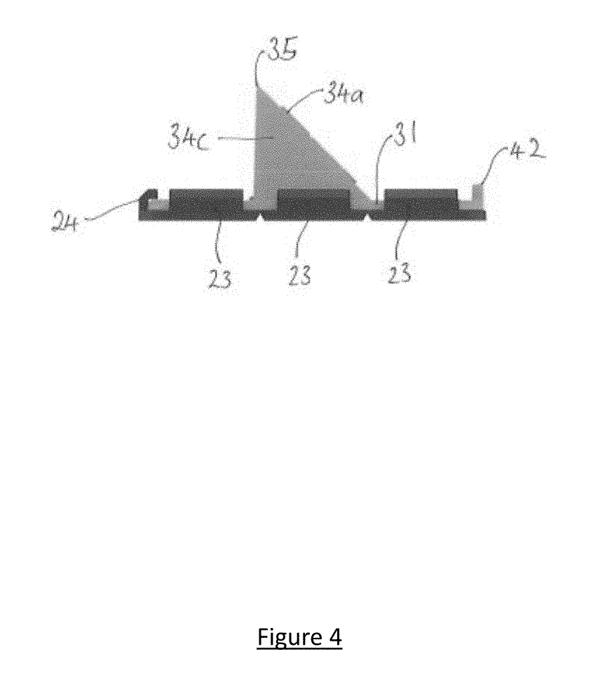

FIG. 4 is a side view of the surveying target assembly illustrated in FIG. 1a;

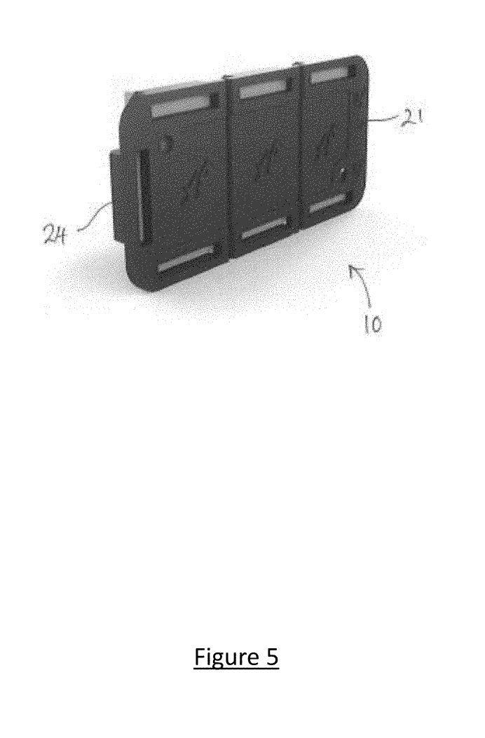

FIG. 5 is a perspective view of the surveying target assembly illustrated in FIG. 1a from the underside thereof; and,

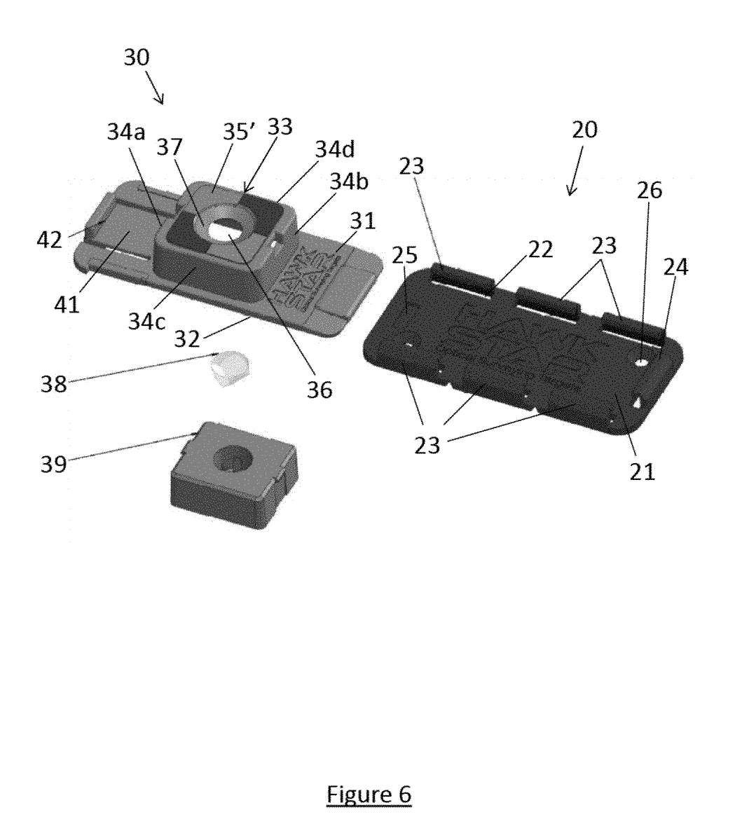

FIG. 6 is an exploded view of a surveying target assembly according to a second embodiment of the present invention.

Referring to the drawings, there is illustrated a surveying target assembly 10 according to an embodiment of the present invention. The assembly 10 is designed to permit surveyors to monitor and track any movement of surveyed bodies, including buildings, bridges, rail tracks (not shown) and the like.

The assembly 10 comprises a docking bay 20 and a radiation reflecting target 30 which can detachably couple with the docking bay 20. The docking bay 20 may be formed of a rigid plastics material and comprises a substantially planar base plate 21 having a substantially rectangular shape, and a longitudinal channel 22 which extends along each longitudinal side of the base plate 21. The channels 22 extend substantially parallel to each other and are separately formed by a plurality of flanges 23 disposed at each longitudinal side of the base plate 21, which arch over a portion of the base plate 21. In this respect, the channels 22 extend above a plane of the base plate 21. In the illustrated embodiment, the base plate 21 comprises three flanges 23 separated along each longitudinal side edge of the base plate 21, which cooperate to form a respective channel 22, however, the skilled person will recognise that different number of flanges 23 may be used.

The docking bay 20 further comprises a longitudinal stop 24 disposed at a distal region of the base plate 21, and may similarly comprise a flange which arches over a portion of the base plate 21 at the distal region thereof. The docking bay 20 further comprises a recess 25 formed in the base plate 21 at a proximal region thereof, and a plurality of apertures 26 again formed in the base plate 21 via which fasteners (not shown), such as screws and bolts can pass to secure the base plate 21 upon the body (not shown) being surveyed.

The target 30 of the assembly 10, may similarly be formed of a rigid plastics material and comprises a base 31 which in use is arranged to extend adjacent the base plate 21 of the docking bay 20. The base 31 comprises a substantially rectangular shape and is sized to extend upon the base plate 21 of the docking bay 20 such that longitudinal side edges 32 of the base 31 extend within the longitudinal channels 22 of the base plate 21. The channels 22 thus act to prevent the target 30 from lifting off the base plate 21.

The target 30 further comprises a housing 33 which extends from a first planar side of the base 31, and which is arranged to house a retroreflector (not shown) for reflecting radiation, such as optical and/or infra-red radiation. The housing 33 comprises a substantially rectangular front and rear wall 34a, 34b, and two side walls 34c, 34d, which extend between the front and rear walls 34a, 34b. In the embodiment illustrated in FIGS. 1 to 5 of the drawings, the rear wall 34b extends substantially perpendicular to the base 31 whereas the front wall 34a is acutely orientated with respect to the base 31 and is coupled to the rear wall 34b along an upper edge thereof to form a ridge 35 of the housing 33. Accordingly, and as illustrated in the drawings, the side walls 34c, 34d comprise a substantially triangular shape.

The target 30 further comprises a window 36 formed in the front wall 34a for admitting radiation incident thereon into the housing 33. The window 36 comprises a substantially circular shape and the cross-sectional area of the window 36 reduces in a direction which is into the housing 33. The reveal 37 surrounding the window 36 comprises a conical taper so that radiation can be accepted into the window 36 through a wide angular range.

Referring to FIG. 2 of the drawings, the target 30 further comprises a retroreflector for reflecting radiation which passes into the housing 30. The retroreflector may comprise a prism 38 for example, which may be coated with a reflective coating for the particular wavelength of radiation used to illuminate the prism 38. The prism 38 is supported within the housing 33 within a cradle 39 which can detachably couple with the housing 33 and which is removably insertable within the housing via an opening (not shown) disposed at the underside of the base 31, adjacent the housing 33. The cradle 39 is configured to support the prism 38 adjacent the window 36 so that radiation which passes through the window 36 can be reflected back out through the window 36. The removeable property of the cradle 39 further enables different prisms 38 to be used within the target 30, to suit the particular radiation used in the surveying process.

The assembly further comprises locking means 40 for locking the target with respect to the docking bay 20. The locking means 40 comprises a tongue 41 formed in the base 31 of the target 30 and is resiliently biased to extend within a plane of the base 31. The tongue 41 may be formed integrally with the base 31 or formed separately and coupled thereto. In either situation, the tongue 41 is coupled at a distal end thereof to the base 31, proximate the region where the front wall 34a of the housing 33 extends from the base 31, and comprises a barb or ramped formation (not shown) disposed at a proximal region thereof which extends to the underside of the tongue 41, namely a second planar side of the target base 31. The tongue 41 further comprises a protuberance 42, such as turned portion of the tongue 41 which extends to the first planar side of the target base 31, disposed at the proximal region, which permits a user to manipulate the tongue 41 for example.

Referring to FIG. 6 of the drawings, there is illustrated an exploded view of a surveying target assembly 10′ according to a second embodiment of the present invention. The features of the assembly 10′ of the second embodiment are substantially the same as the features of the assembly 10 of the first embodiment and so like features have been referenced using the same numerals.

The assembly 10′ of the second embodiment comprises a housing 33 comprising a substantially rectangular front and rear wall 34a, 34b, and two side walls 34c, 34d, which extend between the front and rear walls 34a, 34b. The front and rear wall 34a, 34b, and side walls 34c, 34d extend substantially perpendicular to the base 31, and comprise a substantially rectangular shape. In this embodiment, the housing further comprises an upper wall or ceiling 35′ which extends between an upper edge of the front, rear and side walls 34a-d, substantially parallel to the base 31 and the window 36 is formed in the ceiling 35′. In this respect, the window is arranged to receive radiation which is incident substantially normal to the base 31.

In use of the assembly 10, 10′ of the first or second embodiment, the docking bay 20 is located upon the body (not shown) being surveyed, such as a rail track, and secured thereto by passing fasteners (not shown) through the apertures 26 formed in the base plate 21, into the body. Once the bay 20 has been rigidly secured in place, the target 30 is then detachably coupled with the docking bay 20 by positioning a rear of the target base 31 adjacent a proximal region of the base plate 21 of the docking bay 20, such that the longitudinal side edges 32 of the target base 31 become aligned with a respective channel 22. The target 30 is then moved along the base plate 21 to cause the longitudinal side edges 32 of the base 31 to move along the channels 22. This movement is continued until the rear of the target base 31 abuts the stop 24 formed at the distal region of the base plate 21. The longitudinal separation between the rear of the target base 31 and the barb (not shown) formed on the tongue 41 substantially corresponds to a longitudinal separation between the stop 24 and the recess 25. Accordingly, as the rear of the target base 31 approaches the stop 24, the barb is arranged to ride over a proximal end of the base plate 21, which causes the tongue 41 to deflect away from the base plate 21. However, as the rear of the target base 31 abuts the stop 24, the alignment of the recess 25 with the tongue 41, and the resilient property of the tongue 41 causes the barb (not shown) to enter the recess 25 and thus lock the target 30 with respect to the docking bay 20. The flanges 23 act to prevent the target 30 from lifting off the docking bay 20, while the stop 24 and barb (not shown) prevent any further longitudinal movement of the target 30 relative to the docking bay 20. In this respect, the docking bay 20 is arranged to preserve the orientation of the target 30 and thus minimise any movement of the target 30 relative to the body (not shown).

When it is desired to remove the target 30, a user can lift the tongue 41 by pulling upon the protuberance 42 to lift the barb (not shown) out from the recess 24, and simultaneously slide the target 30 relative to the docking bay 20 to cause the target base 31 to move out from the channels 22. The target 30 can thus be recovered for subsequent use, possibly with an alternative docking bay 20, for example.

1. A surveying target assembly comprising a docking bay and a radiation reflecting target which is arranged to detachably couple with the docking bay.

2. A surveying target assembly according to claim 1, wherein the radiation reflecting target comprises a retroreflector.

3. A surveying target assembly according to claim 2 wherein the radiation reflecting target comprises a base and a housing which extends from the base.

4. A surveying target assembly according to claim 3, wherein the retroreflector is disposed within the housing.

5. A surveying target assembly according to claim 4, wherein the housing comprises a plurality of walls and at least one of the walls comprises a window such that radiation incident upon the target can pass through the window onto the retroreflector.

6. A surveying target assembly according to claim 2, wherein the retroreflector comprises a prism.

7. A surveying target assembly according to claim 3, wherein the housing comprises a front and rear wall and at least the front wall is acutely orientated with respect to the base.

8. A surveying target assembly according to claim 6, wherein the window is disposed in the front wall.

9. A surveying target assembly according to claim 5, wherein the window comprises a cross-sectional area which decreases in a direction which is into the housing.

10. A surveying target assembly according to claim 9, wherein a reveal of the window comprises a conical taper, so that radiation can be admitted through the window through an increased angular range.

11. A surveying target assembly according to claim 3, wherein an interior of the housing is accessible via an opening formed in the base.

12. A surveying target assembly according to claim 4, further comprising a cradle which is arranged to receive the retroreflector.

13. A surveying target assembly according to claim 11, wherein the cradle is detachably coupleable within the housing, via the opening.

14. A surveying target assembly according to claim 3, wherein the docking bay comprises a channel formed along opposing sides thereof for separately receiving a respective side edge of the target base.

15. A surveying target assembly according to claim 14, wherein the channels are formed between a base plate of the docking bay and at least one flange which extends along a periphery of the base plate, over a portion of the base plate.

16. A surveying target assembly according to claim 14, wherein the docking bay further comprises a stop for limiting movement of the target with respect to the docking bay.

17. A surveying target assembly according to claim 1, further comprising locking means for releasably locking the radiation reflecting target to the docking bay.

18. A surveying target assembly according to claim 15, wherein the locking means comprises a tongue which secured at a distal end thereof to the target base, and which is resiliently biased to extend in a plane of the target base, and a recess formed in the base plate of the docking bay.

19. A surveying target assembly according to claim 18, wherein the tongue comprises a barb disposed at an underside thereof, which is arranged to snap locate within the recess, to lock the target with respect to the docking bay.

20. A surveying target assembly according to claim 18, wherein the tongue further comprises a protuberance disposed at a proximal end thereof for enabling a user to manipulate the tongue to unlock the radiation reflecting target from the docking bay.

21. A surveying target assembly according to claim 15, wherein the base plate further comprises at least one aperture formed therein for receiving fasteners for securing the docking bay to body for surveying.
